(19) United States
(12) Patent Application Publication
(10) Pub. No.: US 2003/0127447 A1
(43) Pub. Date: Jul. 10, 2003

(54) Multifunctional cooking apparatus

(76) Inventor: Yuan-Chang Lin, Tai-Ping City (TW)

Correspondence Address: BIRCH STEWART KOLASCH & BIRCH, PO BOX 747, FALLS CHURCH, VA, 22040-0747, US

(21) Appl. No.: 10/200,186

(22) Filed: Jul. 23, 2002

(30) Foreign Application Priority Data
Jan. 8, 2002 (TW) 091200102

(51) Int. Cl. F27D 11/00; A21B 1/22

(52) U.S. Cl. 219/407; 219/438

(57) ABSTRACT

A multifunctional cooking apparatus includes a parabolic-like cooking pot and dome-like cover. A heating element is embedded either in the wall of the cover or the wall of the cooking pot to provide heat transfer respectively. The cooking pot have an opening to create a cooking recess with a parabolic inner wall, and the cover have an opening and formed as a dome-like inner wall, so that the cooking pot and the cover are generally formed as a spherical-like or oval-like cooking chamber by which to concentrate the heat energy therein and cooking food in a variety of ways at a minimal cost, such as baking, steaming, deep-frying, boiling or simmering mode.

### BACKGROUND OF INVENTION

2. Field of the Invention

The present invention relates generally to cooking apparatus, and more particularly to a cooking apparatus generally formed as a spherical-like or oval-like cooking chamber suitable for baking, steaming, deep-frying, boiling or simmering foods.

2. Related Art

In a kitchen, various cooking vessels include pots, skillets, pans, racks, grills, steamers, smokers, fryers, and a variety of other conventional vessels, each of which is adapted to cook food in a particular manner. Additional accessories, such as cooking racks and steaming baskets, can also be incorporated in such cooking vessels as required by the particular manner in which the food is to be cooked. For example, to bake, we'll need an electronic oven as shown in FIG. 1; to fry, stir-fry, and deep-fry, we need a conventional pot as shown in FIG. 2. All of those kitchenware totally needs a huge space to store, and the difficulties in storage are exacerbated for a family who living in small apartment with a tiny kitchen only.

As a consequence of the foregoing situation, there has existed a longstanding need for a new and improved multifunctional cooking apparatus that not only saves money and stove space, but which also allows a plurality of different foods to be prepared in a same cooking apparatus.

### SUMMARY OF INVENTION

In accordance with the present invention there is provide a multifunctional cooking apparatus with a spherical-like or oval-like cooking chamber, by which can concentrating the heat energy and saving energy, and cooking food in a variety of ways in a same cooking chamber.

The multifunctional cooking apparatus includes a parabolic-like cooking pot and dome-like cover. A heating element embedded either in the wall of the cover or the wall of the cooking pot to provide heat transfer respectively. The cooking pot have an opening to create a cooking recess with a parabolic inner wall, and the cover have an opening and formed as a dome-like inner wall, so that the cooking pot and the cover are generally formed as a spherical-like or oval-like cooking chamber.

In accordance with the present invention, the cooking chamber by which can concentrating heat energy therefore could saving energy, and suitable for baking, steaming, deep-frying, boiling or simmering foods.

Other objects, features, and advantages of the invention will be apparent from the ensuing description in conjunction with the accompanying drawings.

### BRIEF DESCRIPTION OF THE DRAWINGS

The preferred embodiment of the multifunctional cooking apparatus according to the present invention is illustrated in the accompanying drawings, wherein:

FIG. 1 is a perspective view of a conventional oven; and

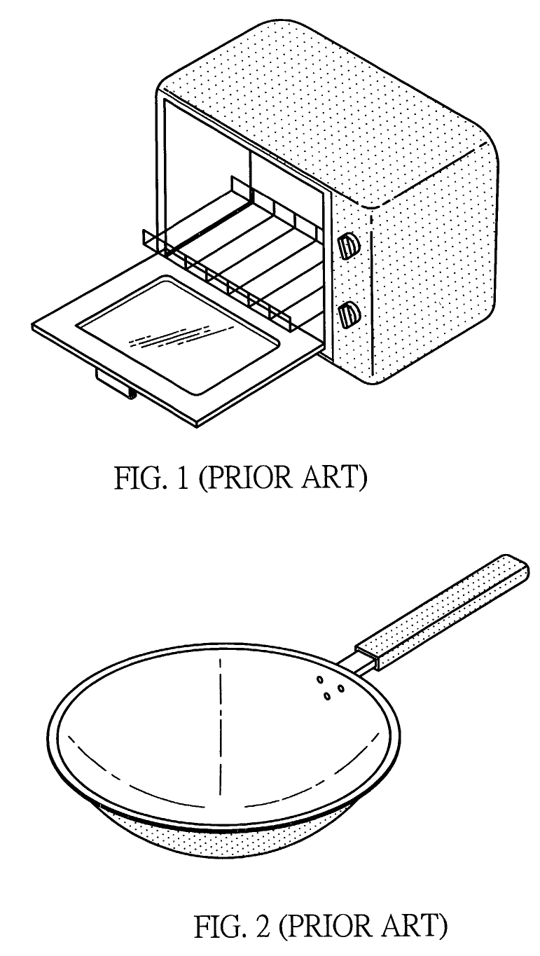

FIG. 2 is a perspective view of a conventional pot.

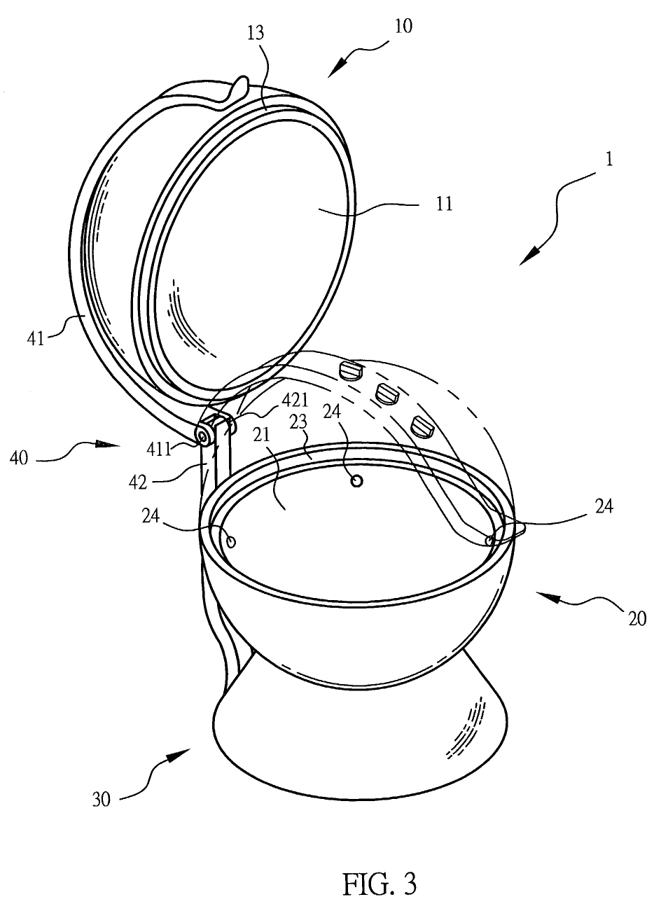

FIG. 3 is a perspective view of a preferred embodiment of the multifunctional cooking apparatus according to the present invention;

FIG. 4 is a cross-sectional view of the preferred embodiment of the multifunctional cooking apparatus according to the present invention;

FIG. 5 is a perspective view of the preferred embodiment of the multifunctional cooking apparatus according to the present invention for baking or steaming foods;

FIG. 6 is a perspective view of the preferred embodiment of the multifunctional cooking apparatus according to the present invention for using in a deep-frying mode, a boiling and simmering mode; and

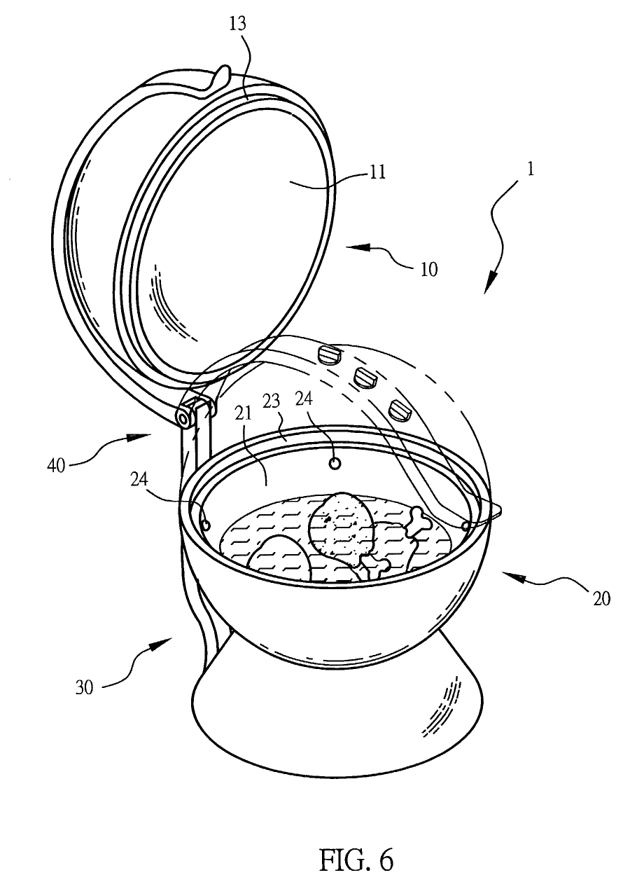

FIG. 5 is a perspective view of another preferred embodiment of the multifunctional cooking apparatus according to the present invention

### DETAILED DESCRIPTION OF PREFERRED EMBODIMENT

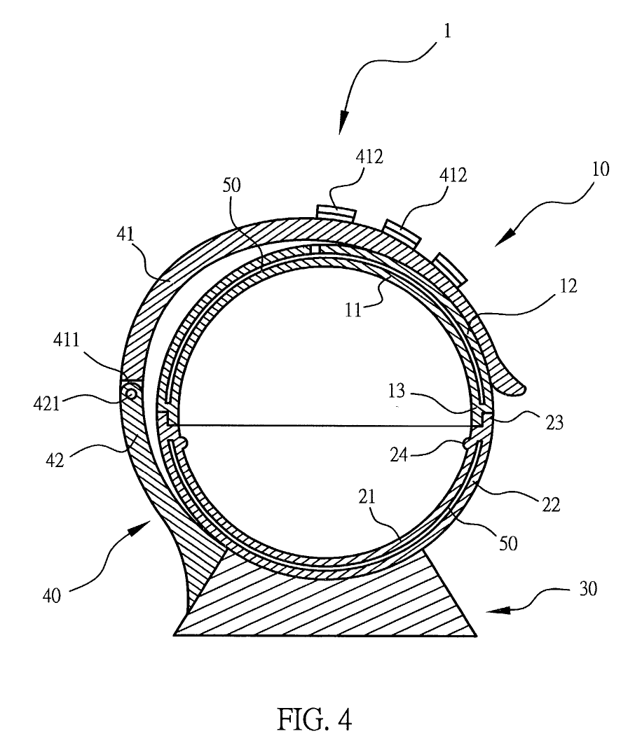

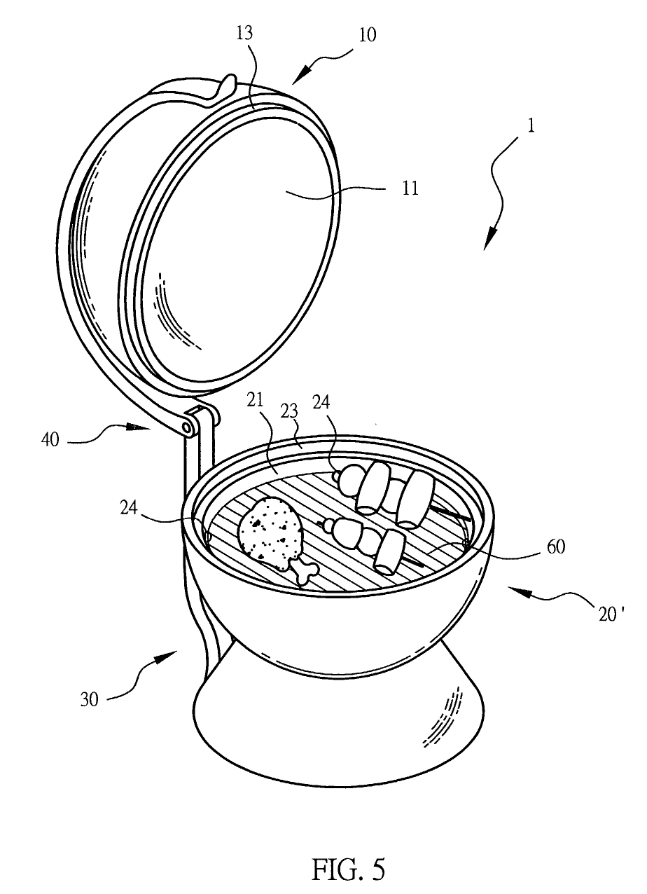

Referring now to drawings wherein the showing is for the purpose of illustrating preferred embodiments of the invention only and not for the purpose of limiting the same. As shown in FIGS. 3 and 4, the multifunctional cooking apparatus 1 comprises a cooking pot 20 for cooking food, a cover 10 for closing the cooking pot 20, a base portion 30 for supporting the cooking pot 20, a swivel base portion 40 by which connected the cover 10 and the cooking pot 20. A heating element is embedded either in the wall of the cover 10 or the wall of the cooking pot 20 to provide heat transfer respectively.

As can best seen by reference to FIG. 4, the cover 10 comprises an inner wall 11 and an outer wall 12. A space for installing the heating element 50 is defined between the inner wall 11 and the outer wall 12. The inner wall 11 is provided with a first engaging flange 13 and formed in a dome-like shape as a cover of the multifunctional cooking apparatus.

The cooking pot 20 comprises an inner wall 21 and an outer wall 22. A space for installing the heating element 50 is defined between the inner wall 21 and the outer wall 22. The inner wall 21 is formed in a parabolic-like shape and provided with a plurality of protrusions 24 and a second engaging flange 23. The second engaging flange 23 is dimensioned to be engageable with the first engaging flange 13 of the cover 10.

As can best seen by reference to FIG. 3, a base portion 30 is provided for supporting the cooking pot 20. A swivel base portion 40 comprises a upper swivel arm 41 and a lower swivel arm 42. The lower end of the lower swivel arm 42 is connected to one side of the base portion 30, and the upper end of the lower swivel arm 42 is connected to the lower end of the upper swivel arm 41 with a pair of pivoting portion designated by the reference number 411,421. The cover 10 is disposed beneath the upper swivel arm 41, therefore, by operating the upper swivel arm 41 that could bring the cover 10 to open or close the cooking pot 20.

Returning once more to FIG. 4, it can be seen that the heating element 50 embedded either in the wall of the cover 10 or the wall of the cooking pot 20. A controlling means 412 is provided on the upper swivel arm 41 with known electronic control circuit (not shown) to regulate the power to the heating element 50.

In the embodiment shown, a spherical-like or oval-like cooking chamber is defined between the cooking pot 20 and the cover 10; therefore, the heat when generated from the heating element 50 is reflected by the inner wall 11, 21 and can be concentrated in the cooking chamber for saving energy.

In FIG. 5, to use the multifunctional cooking apparatus 1 in a steaming, deep-frying, boiling or simmering cooking mode, a cooking rack 60 is provided to support the food. The cooking rack 60 is dimensioned to be support by the protrusions 24 on the inner wall 21, so that the cooking rack 60 can rest on an upper edge of the cooking pot 20.

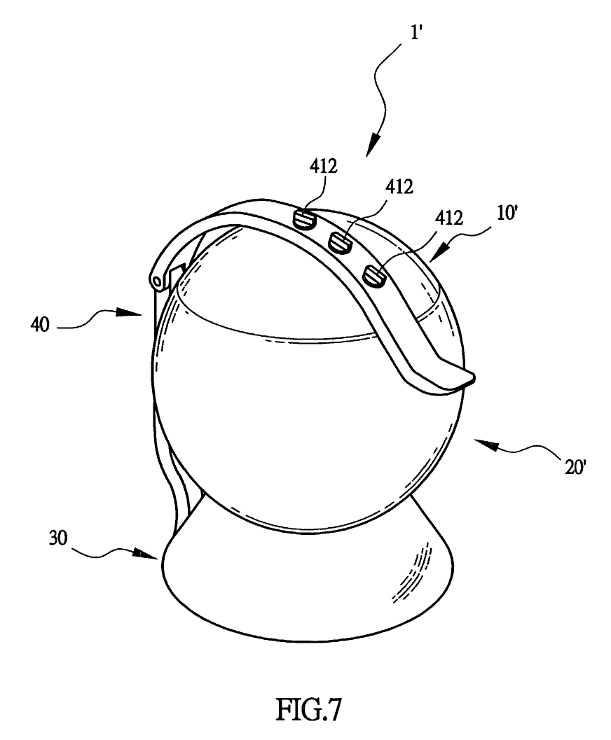

In FIG. 6, to use the multifunctional cooking apparatus 1 in a baking or steaming cooking mode, the temperature in the cooking pot 20 can be regulated by the controlling means 412 to a predetermined cooking power and time.

In addition, the present invention further includes another embodiment of the multifunctional cooking apparatus 1′ as shown in FIG. 7, the vertical dimensions of the cover 10′ and the cooking pot 20′ thereof are different from each other.

Having thereby described the subject matter of the present invention, it should be apparent that many substitutions, modifications, and variations of the invention are possible in light of the above teachings. It is therefore to be understood that the present invention can only be defined in the claims attached to and taken as a portion of this patent specification.

Having thus described in the invention, the following is claimed:

1. A multifunctional cooking apparatus comprising:
a cooking pot having an opening to create a cooking recess with a parabolic inner wall;
a cover having an opening, and forming a dome-like inner wall to cover the cooking pot;
a base portion for supporting the cooking pot; and
a heating element embedded either in the cooking pot or the cover for providing heat transfer respectively.

2. The multifunctional cooking apparatus as in claim 1 further includes a swivel base portion extending upwardly from one side of the base portion, wherein said swivel base portion comprising:
a lower swivel arm attached to the base portion; and
an upper swivel arm having a lower portion for pivoting to the lower swivel arm with a pair of pivoting portion, and an upper portion for connecting to the cover.

3. The multifunctional cooking apparatus as in claim 1 wherein said cooking pot includes an inner wall and an outer wall, and forming a space for receiving the heating element.

4. The multifunctional cooking apparatus as in claim 2 wherein said upper swivel arm further includes a controlling means for controlling the heating element.

5. The multifunctional cooking apparatus as in claim 1 wherein said cooking pot further includes several protrusions for supporting a cooking rack.

6. The multifunctional cooking apparatus as in claim 1 wherein the cover includes an engaging flange for matching the cooking pot with a second engaging flange thereon.

7. The multifunctional cooking apparatus as in claim 1 wherein the cover or the cooking pot are generally forming as a hemispherical-like shape.

8. The multifunctional cooking apparatus as in claim 1 wherein the cover and the cooking pot are generally forming as a hemispherical-like shape with a different vertical dimension.

9. The multifunctional cooking apparatus as in claim 1 wherein the cover and/or the cooking pot includes an inner wall having a parabolic surface thereon.
